(19) United States
(12) Patent Application Publication
(10) Pub. No.: US 2024/0194065 A1
(43) Pub. Date: Jun. 13, 2024

(54) METHODS FOR THE INFRASTRUCTURE-SUPPORTED ASSISTANCE OF A MOTOR VEHICLE

(71) Applicant: Robert Bosch GmbH, Stuttgart (DE)

(72) Inventors: Michael Gabb, Gaeufelden (DE); Stefan Nordbruch, Leonberg (DE)

(21) Appl. No.: 18/553,896

(22) PCT Filed: Aug. 25, 2022
(86) PCT No.: PCT/EP2022/073704

§ 371 Date: Oct. 4, 2023

(30) Foreign Application Priority Data
Sep. 1, 2021 (DE) 10 2021 209 623.9

(51) Int. Cl. G08G 1/0967; G08G 1/01; G08G 1/16; H04W 4/44

(52) U.S. Cl. CPC G08G 1/096725; G08G 1/0116; G08G 1/0129; G08G 1/096783; G08G 1/166; H04W 4/44

(57) ABSTRACT

A method for the infrastructure-supported, at least partially automated, guidance of a motor vehicle. The method includes: receiving environment signals; analyzing the environment to ascertain an analysis result, the analyzing including an object recognition in order to detect an object in the environment of the motor vehicle, and/or a free space recognition in order to recognize an occupancy of an area in the environment of the motor vehicle to ascertain an occupancy status that indicates whether the area is free or occupied; generating infrastructure assistance data signals that represent infrastructure assistance data for the infrastructure-supported, at least partially automated guidance of the motor vehicle, based on the analysis result; and outputting the infrastructure assistance data signals.

### FIELD

The present invention relates to methods for the infrastructure-supported assistance of a motor vehicle in an at least partially automated driving task, to a method for the at least partially automated guidance of a motor vehicle, to a device, to a computer program, and to a machine-readable storage medium.

### BACKGROUND INFORMATION

German Patent Application No. DE 10 2013 001 326 A1 describes an automobile that is designed to exchange operating data with a traffic object located in the surroundings of the automobile, and as a result to match a driving maneuver of the automobile with the traffic object.

### SUMMARY

An object of the present invention includes providing efficient infrastructure-supported assistance of a motor vehicle in an at least partially automated driving task so that the motor vehicle can be guided efficiently in an at least partially automated manner.

This object may achieved by features of the present invention. Advantageous configurations of the present invention are disclosed herein.

According to a first aspect of the present invention, a method for the infrastructure-supported assistance of a motor vehicle in an at least partially automated driving task is provided.

According to an example embodiment of the present invention, the method includes the following steps:
receiving environment signals that represent an environment of the motor vehicle;
analyzing the environment in order to ascertain an analysis result, wherein the analyzing comprises an object recognition in order to detect an object in the environment of the motor vehicle, and/or wherein the analyzing comprises a free space recognition in order to recognize an occupancy of an area in the environment of the motor vehicle in order to ascertain an occupancy status that indicates whether the area is free or occupied, wherein the analysis result indicates whether an object has been detected in the environment of the motor vehicle, and/or wherein the analysis result indicates the ascertained occupancy status of the area in the environment of the motor vehicle;
generating infrastructure assistance data signals that represent infrastructure assistance data for the infrastructure-supported assistance of the motor vehicle in an at least partially automated driving task, based on the analysis result; and
outputting the infrastructure assistance data signals.

According to a second aspect of the present invention, a method for the at least partially automated guidance of a motor vehicle is provided. According the an example embodiment of the present invention, the method includes the following steps:
receiving infrastructure assistance data signals that represent infrastructure assistance data for the infrastructure-supported assistance of the motor vehicle in an at least partially automated driving task;
wherein the infrastructure assistance data comprise an analysis result that indicates whether an object has been detected in the environment of the motor vehicle, and/or wherein the analysis result indicates an occupancy status of an area in the environment of the motor vehicle; and/or
wherein the infrastructure assistance data comprise one or more changes in relation to a prior analysis result that indicated whether an object had been detected in the environment of the motor vehicle, and/or wherein the prior analysis result indicated an occupancy status of an area in the environment of the motor vehicle;
generating control signals for the at least partially automated control of a lateral and/or longitudinal guidance of the motor vehicle based on the infrastructure assistance data signals; and
outputting the generated control signals.

According to a third aspect of the present invention, a device is provided that is equipped to carry out all the steps of the method according to the first aspect of the present invention and/or according to the second aspect of the present invention.

According to a fourth aspect of the present invention, a computer program is provided that comprises commands that, when the computer program is executed by a computer, for example by the device according to the third aspect, cause the computer to carry out a method in accordance with the first aspect of the present invention and/or in accordance with the second aspect of the present invention.

According to a fifth aspect of the present invention, a machine-readable storage medium on which the computer program according to the fourth aspect of the present invention is stored is made available.

According to the present invention, the above object may be achieved in that an environment of the motor vehicle is analyzed in order to detect objects in the environment of the motor vehicle, and/or in order to recognize a respective movement of areas in the environment of the motor vehicle in order to ascertain a corresponding occupancy status that indicates whether the corresponding area is free or occupied. Based on this analysis, i.e., based on a corresponding analysis result, the motor vehicle can then be guided efficiently in an at least partially automated manner. In such case, infrastructure assistance data are ascertained in an infrastructure, based on the analysis result, with infrastructure assistance data signals that represent these ascertained infrastructure assistance data being transmitted to the motor vehicle. The transmitting comprises for example transmitting via a communications network, which may comprise for example a wireless and/or a wired communications network.

According to an example embodiment of the present invention, the motor vehicle receives these infrastructure assistance data signals, and in particular the motor vehicle receives these signals via the communications network, so that these infrastructure assistance data are used in the motor vehicle in order to generate and output control signals for the at least partially automated control of a lateral and/or longitudinal guidance of the motor vehicle. According to one specific embodiment of the present invention, the lateral and/or longitudinal guidance of the motor vehicle is controlled based on the output control signals.

The motor vehicle thus receives support or assistance by the infrastructure in its at least partially automated driving task.

Owing to the fact that it is clearly defined for the infrastructure how the environment of the motor vehicle is to be analyzed, i.e., by a free space recognition and/or by an object recognition, a sort of standard is created as to which data are transferred to the motor vehicle for support: the infrastructure assistance data that are ascertained based on the analysis result.

According to an example embodiment of the present invention, an object recognition and/or a free space recognition can be carried out particularly efficiently in an infrastructure in so far as there is as a rule greater computing capacity for a corresponding analysis of the environment available in an infrastructure than in the motor vehicle itself. As a result, therefore, the analysis of the environment can be carried out particularly efficiently.

Further, according to an example embodiment of the present invention, the infrastructure advantageously has more information available to it for analyzing the environment accordingly than there is in the motor vehicle. For example, environment sensors that acquire the environment of the motor vehicle are arranged spatially distributed within the infrastructure. Environment sensor data corresponding to the acquisition are for example used to analyze the environment. These environment sensor data in each case describe an environment of the motor vehicle, and thus according to one specific embodiment are comprised by the environment signals.

Further, according to an example embodiment of the present invention, infrastructure environment sensors, i.e., environment sensors that are arranged spatially distributed within the infrastructure, may acquire regions in the environment of the motor vehicle that cannot be acquired for example by onboard environment sensors, because for example an object is located between the motor vehicle and the region in the environment of the motor vehicle, making acquisition of the region more difficult or even impossible for the onboard environment sensors.

Furthermore, the infrastructure knows the surroundings (better in contrast to the motor vehicle)— including the changes over time— and can incorporate this information in the analysis as well.

Thus the infrastructure knows, e.g., the distance between the infrastructure environment sensors and areas/ground/stationary objects, and with this information it can, e.g., ascertain/recognize whether a scene is changing. Thus, it can, e.g., be ascertained whether a region is free or occupied.

Furthermore, according to an example embodiment of the present invention, it can thus, e.g., be ascertained whether an infrastructure environment sensor is functioning correctly (for example by comparison with references) and thus whether an analysis of the environment is correct.

In the light of this, therefore, in particular the technical advantage is brought about that a concept for the efficient infrastructure-supported assistance of a motor vehicle in an at least partially automated driving task is made available, so that the motor vehicle can be guided efficiently in an at least partially automated manner.

The method in accordance with the first aspect of the present invention therefore provides the concept from the point of view of the infrastructure. The method in accordance with the second aspect provides the concept from the point of view of the motor vehicle. This means, for example, that the method in accordance with the first aspect is carried out for example externally to the motor vehicle, i.e., in the infrastructure. This means in particular that the method in accordance with the second aspect is carried out for example in the motor vehicle, i.e., internally to the motor vehicle.

Statements made in conjunction with the method according to the first aspect of the present invention apply analogously to the method in accordance with the second aspect of the present invention, and vice versa. That is to say, therefore, in particular that technical functionalities of the method according to the first aspect arise from corresponding technical functionalities of the method according to the second aspect, and vice versa. If therefore for example a step of transmitting and/or outputting is described for the method according to the first aspect, thus a corresponding step of receiving is disclosed for the method according to the second aspect, even if this is not explicitly described.

The specific embodiments and exemplary embodiments of the present invention described herein may be combined with each other in any form whatsoever, even if this is not explicitly described.

According to one specific embodiment of the present invention, the method according to the first aspect and/or the method according to the second aspect is/are in each case a computer-implemented method.

Travel of the motor vehicle in the context of the description is for example travel guided in an at least partially automated manner, in particular infrastructure-supported travel guided in an at least partially automated manner.

An at least partially automated driving task comprises for example travel guided in an at least partially automated manner. The motor vehicle is therefore guided for example in an at least partially automated manner. An at least partially automated driving task therefore comprises at least partially automated guidance of the motor vehicle.

The formulation “at least partially automated guidance” comprises one or more of the following cases: assisted guidance, partially automated guidance, highly automated guidance, fully automated guidance. The formulation “in an at least partially automated manner” therefore comprises one or more of the following formulations: in an assisted manner, in a partially automated manner, in a highly automated manner, in a fully automated manner.

Assisted guidance means that a driver of the motor vehicle constantly performs either the lateral or the longitudinal guidance of the motor vehicle. The other driving task in each case (i.e., control of the longitudinal or the lateral guidance of the motor vehicle) is carried out automatically. This means, therefore, that during assisted guidance of the motor vehicle either the lateral or the longitudinal guidance is controlled automatically.

Partially automated guidance means that, in a specific situation (for example: driving on a freeway, driving within a parking facility, overtaking an object, driving within a lane that is defined by lane markings) and/or for a certain period of time, a longitudinal guidance and a lateral guidance of the motor vehicle are controlled automatically. A driver of the motor vehicle does not have to control the longitudinal and lateral guidance of the motor vehicle himself manually. However, the driver must constantly monitor the automatic control of the longitudinal and lateral guidance in order to be able to intervene manually if need be. The driver must be ready at all times to take over guidance of the motor vehicle completely.

Highly automated guidance means that, for a certain period of time in a specific situation (for example: driving on a freeway, driving within a parking facility, overtaking an object, driving within a lane that is defined by lane markings), a longitudinal guidance and a lateral guidance of the motor vehicle are controlled automatically. A driver of the motor vehicle does not have to control the longitudinal and lateral guidance of the motor vehicle himself manually. The driver does not have to constantly monitor the automatic control of the longitudinal and lateral guidance in order to be able to intervene manually if need be. If need be, a takeover request is automatically issued to the driver to take over the control of the longitudinal and lateral guidance, in particular issued with an adequate time reserve. The driver must therefore be potentially capable of taking over control of the longitudinal and lateral guidance. Limits of the automatic control of the lateral and longitudinal guidance are recognized automatically. In the case of highly automated guidance, it is not possible to bring about a minimal-risk state automatically in every starting situation.

Fully automated guidance means that, in a specific situation (for example: driving on a freeway, driving within a parking facility, overtaking an object, driving within a lane that is defined by lane markings), a longitudinal guidance and a lateral guidance of the motor vehicle are controlled automatically. A driver of the motor vehicle does not have to control the longitudinal and lateral guidance of the motor vehicle himself manually. The driver does not have to monitor the automatic control of the longitudinal and lateral guidance in order to be able to intervene manually if need be. Before the automatic control of the lateral and longitudinal guidance is ended, a request is automatically issued to the driver to take over the driving task (controlling the lateral and longitudinal guidance of the motor vehicle), in particular issued with an adequate time reserve. Should the driver fail to take over the driving task, reversion to a minimal-risk state occurs automatically. Limits of the automatic control of the lateral and longitudinal guidance are recognized automatically. In all situations, it is possible to revert automatically to a minimal-risk system state.

“Infrastructure assistance data” in the context of the description designates data that are suitable for at least partially automated guidance of the motor vehicle. Infrastructure assistance data are therefore in particular suitable to be used for generating control signals for the at least partially automated control of a lateral and/or longitudinal guidance of the motor vehicle.

According to one specific embodiment, the infrastructure assistance data signals are generated based on the analysis result in such a way that the infrastructure assistance data comprise the analysis result.

This brings about, for example, the technical advantage that the analysis result can be made available to the motor vehicle efficiently.

That is to say, therefore, in particular that according to one specific embodiment the infrastructure assistance data comprise the analysis result.

According to one specific embodiment of the present invention, the analysis result is compared with a prior analysis result in order to ascertain one or more changes in relation to the prior analysis result, the infrastructure assistance data signals being generated based on the one or more ascertained changes.

This brings about, for example, the technical advantage that corresponding changes compared with the prior analysis result can be made available to the motor vehicle efficiently.

According to this specific embodiment of the present invention, therefore, for example, the infrastructure assistance data comprise the one or more ascertained changes.

According to one specific embodiment of the present invention, the infrastructure assistance data signals are generated based on the one or more ascertained changes in such a way that the infrastructure assistance data comprise the one or more ascertained changes and are free from the analysis result.

This brings about, for example, the technical advantage that a data volume that is to be transferred to the motor vehicle can be reduced efficiently in so far as according to this specific embodiment only ascertained changes relative to a prior analysis result are communicated to the motor vehicle.

According to this specific embodiment of the present invention, therefore, the infrastructure assistance data comprise the one or more ascertained changes and are free from the analysis result. The motor vehicle obtains, i.e., receives, merely the ascertained changes and not the analysis result.

According to one specific embodiment of the present invention, if no occupancy of the area was able to be recognized using the free space recognition, the occupancy status indicates that the occupancy of the area is unknown.

This brings about, for example, the technical advantage that the information that the free space recognition has not yielded a clear result can be communicated to the motor vehicle efficiently.

That is to say, therefore, in particular that according to one specific embodiment the occupancy status indicates that the occupancy of the area is unknown.

According to one specific embodiment of the present invention, if, using the free space recognition, and in particular additionally using the object recognition, no clear result was able to be ascertained, the occupancy status indicates that the occupancy of the area is unknown.

According to one specific embodiment of the present invention, if, using the free space recognition, and in particular additionally using the object recognition, it is ascertained that the area cannot be examined, e.g., because a truck is concealing the area, the occupancy status indicates that the occupancy of the area is unknown.

According to one specific embodiment of the present invention, based on the analysis result, a traffic scene in the environment of the motor vehicle is analyzed to see whether or not it is safe for the motor vehicle to travel along a determined trajectory, the infrastructure assistance data signals being generated based on the analysis of the traffic scene, so that the infrastructure assistance data comprise the information of whether or not it is safe for the motor vehicle to travel along the determined trajectory.

This brings about, for example, the technical advantage that it can be analyzed efficiently whether or not it is safe for the motor vehicle to travel along a determined trajectory.

According to one specific embodiment of the present invention, in this respect the infrastructure assistance data comprise the information of whether or not it is safe for the motor vehicle to travel along the determined trajectory.

According to one specific embodiment of the present invention, a behavior of the motor vehicle is predicted, with the determined trajectory being ascertained based on the predicted behavior.

This brings about, for example, the technical advantage that the determined trajectory can be ascertained efficiently.

According to one specific embodiment of the present invention, trajectory signals that represent a trajectory planned using the motor vehicle along which the motor vehicle is intended to be guided in an at least partially automated manner are received, the determined route being ascertained based on the planned trajectory.

This brings about, for example, the technical advantage that the determined route can be ascertained efficiently.

According to this specific embodiment of the present invention, therefore, the motor vehicle itself plans a trajectory and transmits this planned trajectory to the infrastructure, so that, based thereon, the determined route can be ascertained in the infrastructure.

According to one specific embodiment of the present invention, the traffic scene is analyzed from comfort travel aspects and/or from emergency reaction travel aspects in order to ascertain whether or not it is safe for the motor vehicle to travel along the determined trajectory from the corresponding aspect or aspects, so that the infrastructure assistance data comprise the information of whether or not it is safe for the motor vehicle to travel along the determined trajectory from the corresponding aspect or aspects.

This brings about, for example, the technical advantage that it can be ascertained efficiently whether or not it is safe for the motor vehicle to travel from various aspects as well.

Normal travel aspects are defined as follows: route of the motor vehicle is traveled as planned.

Comfort travel aspects are defined as follows: no abrupt changes in braking, steering and/or speed.

Emergency reaction travel aspects are defined as follows: no comfort. Focus on safety. That is to say, even abrupt and/or non-comfortable changes in braking, steering and/or speed are allowed.

According to one specific embodiment of the present invention, in the case of unsafe travel along the predetermined trajectory, emergency signals are generated and output that indicate that if the motor vehicle travels along the determined trajectory an emergency may occur for the motor vehicle.

This brings about, for example, the technical advantage that it is possible to signal efficiently to the motor vehicle that in the case of travel of the motor vehicle an emergency may occur owing to the determined trajectory. This brings about, for example, the technical advantage that the motor vehicle can prepare efficiently for such a possible emergency.

According to one specific embodiment of the present invention, the emergency signals are generated in such a way that they describe the emergency.

This brings about, for example, the technical advantage that information about the possible emergency can be made available to the motor vehicle efficiently.

In one specific embodiment of the present invention, emergency signals that indicate that if the motor vehicle travels along the determined trajectory an emergency may occur for the motor vehicle are received.

In one specific embodiment of the present invention, the emergency signals describe the emergency.

In one specific embodiment of the present invention, action recommendation signals that represent one or more action recommendations for the motor vehicle are generated and output based on the analysis result.

This brings about, for example, the technical advantage that the motor vehicle can be guided efficiently in an at least partially automated manner based on the one or more action recommendations.

In one specific embodiment of the present invention, action recommendation signals that represent one or more action recommendations for the motor vehicle are received.

The one or more action recommendations, according to one specific embodiment of the present invention, comprise in each case an element selected from the following group of action recommendations: traveling along a setpoint trajectory, traveling along an emergency trajectory in the event of an emergency.

In one specific embodiment of the present invention, a respective measure of confidence, indicating how accurate and/or reliable the information represented by the corresponding output signals is, is ascertained for the output signals.

This brings about, for example, the technical advantage that the motor vehicle can be informed efficiently how reliable the information that the corresponding output signals represent is.

Output signals in the context of the description comprise for example one or more of the following signals: infrastructure assistance signals, emergency signals, action recommendation signals.

In one specific embodiment of the present invention, the object recognition comprises ascertaining one or more object properties of a recognized object, so that the result of the object recognition indicates the one or more ascertained object properties, and/or wherein the free space recognition comprises ascertaining one or more area properties of the area, so that the result of the free space recognition indicates the one or more ascertained area properties.

This brings about, for example, the technical advantage that object properties and/or area properties can be ascertained efficiently, so that these properties can be communicated to the motor vehicle for its at least partially automated driving task.

In one embodiment of the present invention, the one or more object properties is/are in each case an element selected from the following group of object properties: position, dimension, color, speed, acceleration, nature.

This brings about, for example, the technical advantage that object properties that are particularly useful for at least partially automated driving can be selected.

According to one specific embodiment of the present invention, the one or more ascertained area properties are in each case an element selected from the following group of area properties: position, dimension, color, nature.

This brings about, for example, the technical advantage that area properties that are particularly useful for the at least partially automated driving can be selected.

According to one specific embodiment of the present invention, the received signals are checked for how accurate and/or reliable the information represented by the corresponding received signals is, the control signals being generated based on a result of the check.

This brings about, for example, the technical advantage that the control signals can be generated efficiently. In particular, this brings about the technical advantage that a measure of confidence, indicating how accurate and/or reliable the information represented by the corresponding output signals is, can be taken into account efficiently when generating the control signals. Should for example a corresponding measure of confidence be less than, or less than or equal to, a predetermined measure of confidence threshold value, control signals are generated in such a way that in the case of controlling the lateral and/or longitudinal guidance of the motor vehicle based on these control signals the motor vehicle is guided at a lower maximum permissible speed compared with the case according to which the measure of confidence is greater than the predetermined measure of confidence threshold value. This therefore means in particular that the higher a measure of confidence is, the higher for example a maximum permissible speed of the motor vehicle during the at least partially automated guidance can be.

For example, for a measure of confidence that is less than, or less than or equal to, a predetermined measure of confidence threshold value, the control signals are generated in such a way that when controlling the lateral and/or longitudinal guidance of the motor vehicle based on these control signals a distance between a preceding road user and the motor vehicle is increased.

Received signals in the context of the description comprise for example one or more of the following signals: infrastructure assistance data signals, emergency signals, action recommendation signals.

According to one specific embodiment of the present invention, the received signals are checked based on onboard data of the motor vehicle as a reference relative to the information represented by the corresponding received signals.

This brings about, for example, the technical advantage that the received signals can be checked efficiently.

Onboard data of the motor vehicle comprise for example one or more of the following types of data: environment sensor data from one or more onboard environment sensors, the environment sensor data corresponding to a respective acquisition of the environment sensor or sensors of the motor vehicle, environment data that describe the environment of the motor vehicle.

In one specific embodiment of the present invention, it is established that the received signals, except for emergency signals that indicate that in the event of the motor vehicle traveling along a determined trajectory an emergency may occur for the motor vehicle, are heartbeat signals, so that received signals, except for emergency signals, are checked to see whether they have been received in accordance with the heartbeat that is to be expected.

This brings about, for example, the technical advantage that failure of the infrastructure and/or failure of a communications path between motor vehicle and infrastructure can be recognized efficiently, so that emergency measures can be taken efficiently based on such recognition.

In one specific embodiment of the present invention, detected objects are classified, the analysis result comprising the classified detected objects. An object may for example be classified as follows: motor vehicle, for example automobile, truck, powered cycle, for example motorcycle, bicycle, human, animal, child.

In one specific embodiment of the present invention, the method according to the first aspect and/or according to the second aspect is carried out using the device according to the third aspect.

An environment sensor in the context of the description is for example one of the following environment sensors: radar sensor, lidar sensor, ultrasonic sensor, magnetic field sensor, infrared sensor, and video sensor, in particular video sensor of a video camera, for example a stereo video camera.

The terms “assist” and “support” can be used synonymously.

Exemplary embodiments of the present invention are illustrated in the figures, and are discussed in greater detail in the following description.

### BRIEF DESCRIPTION OF THE DRAWINGS

FIG. 1 shows a flowchart of a method according to an example embodiment of the first aspect of the present invention.

FIG. 2 shows a flowchart of a method according to an example embodiment of the second aspect of the present invention.

FIG. 3 shows a device, according to an example embodiment of the present invention.

FIG. 4 shows an infrastructure-supported motor vehicle that is guided in an at least partially automated manner, according to an example embodiment of the present invention.

FIG. 5 shows a machine-readable storage medium, according to an example embodiment of the present invention.

FIG. 6 shows a schematic illustration of an analysis result of an analysis of an environment of a motor vehicle, according to an example embodiment of the present invention.

FIG. 7 shows two motor vehicles.

FIG. 8 shows three motor vehicles.

Below, identical reference numerals can be used for identical features.

### DETAILED DESCRIPTION OF EXAMPLE EMBODIMENTS

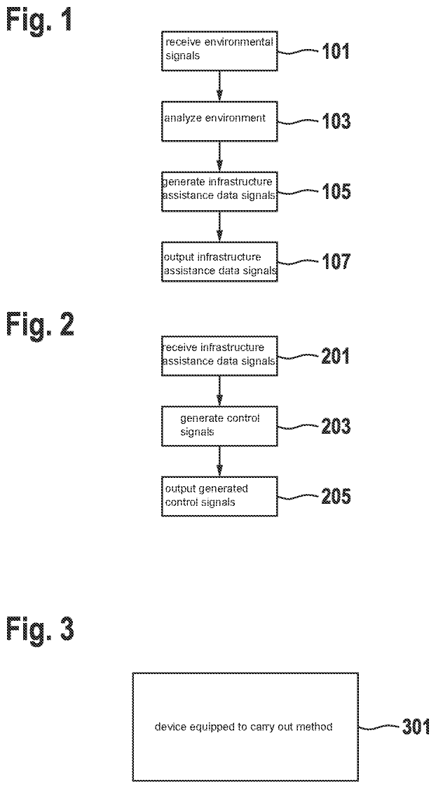

FIG. 1 shows a flowchart of a method for the infrastructure-supported assistance of a motor vehicle for an at least partially automated driving task, comprising the following steps:
receiving 101 environment signals that represent an environment of the motor vehicle;
analyzing 103 the environment in order to ascertain an analysis result, the analyzing comprising an object recognition in order to detect an object in the environment of the motor vehicle, and/or the analyzing comprising a free space recognition in order to recognize an occupancy of an area in the environment of the motor vehicle in order to ascertain an occupancy status that indicates whether the area is free or occupied, the analysis result indicating whether an object has been detected in the environment of the motor vehicle, and/or the analysis result indicating the ascertained occupancy status of the area in the environment of the motor vehicle;
generating 105 infrastructure assistance data signals that represent infrastructure assistance data for the infrastructure-supported assistance of the motor vehicle in an at least partially automated driving task, based on the analysis result; and
outputting 107 the infrastructure assistance data signals.

In one specific embodiment, the output infrastructure assistance data signals are transmitted to the motor vehicle via a communications network. The communications network comprises for example a mobile phone network and/or a WLAN communications network.

FIG. 2 shows a flowchart of a method for the at least partially automated guidance of a motor vehicle, comprising the following steps:
receiving 201 infrastructure assistance data signals that represent infrastructure assistance data for the infrastructure-supported assistance of the motor vehicle in an at least partially automated driving task;
wherein the infrastructure assistance data comprise an analysis result that indicates whether an object has been detected in the environment of the motor vehicle, and/or wherein the analysis result indicates an occupancy status of an area in the environment of the motor vehicle; and/or
wherein the infrastructure assistance data comprise one or more changes in relation to a prior analysis result that indicated whether an object had been detected in the environment of the motor vehicle, and/or wherein the prior analysis result indicated an occupancy status of an area in the environment of the motor vehicle;
generating 203 control signals for the at least partially automated control of a lateral and/or longitudinal guidance of the motor vehicle based on the infrastructure assistance data signals; and
outputting 205 the generated control signals.

In one specific embodiment, the lateral and/or longitudinal guidance of the motor vehicle is/are controlled in an at least partially automated manner based on the output control signals.

FIG. 3 shows a device 301 that is equipped to carry out all the steps of the method according to the first aspect and/or according to the second aspect.

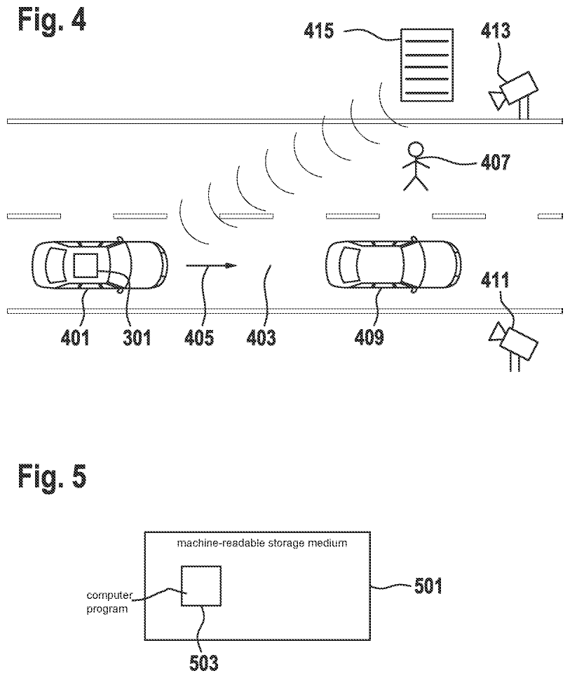

FIG. 4 shows a motor vehicle 401 during at least partially automated travel on a road 403. A direction of travel of the motor vehicle 401 is represented by an arrow bearing the reference numeral 405. The motor vehicle 401 comprises the device 301 of FIG. 3.

On the road 403 ahead of the motor vehicle relative to the direction of travel 405 there are a pedestrian 407 and a further motor vehicle 409. A first video camera 411 and a second video camera 413 are arranged in a stationary manner on the road 403. In one specific embodiment, not shown, more or fewer than 2 video cameras and/or other environment sensors are provided. The two video cameras 411, 413 are an example of environment sensors of an infrastructure.

The two video cameras 411, 413 acquire their respective environment and thus also an environment of the motor vehicle 401. Environment sensor data corresponding to these acquisitions are transmitted as environment signals that represent or describe an environment of the motor vehicle 401 to an RSU 415, which is an example of a device according to the third aspect.

The abbreviation “RSU” stands for “roadside unit”. The following terms may also be used synonymously instead of “RSU”: roadside unit, roadside infrastructure unit, communication module, roadside communication module, roadside radio unit, roadside transmission station.

In a specific embodiment, not shown, the environment sensor data, instead of or in addition to the RSU 415, are generated in an external processing unit that is implemented for example in a Cloud infrastructure and/or in a backend infrastructure.

The RSU 415 processes the environment signals in line with the concept described here and transmits corresponding infrastructure assistance data signals via a wireless communications network, for example mobile network and/or WLAN, to the motor vehicle 401.

The motor vehicle 401 receives these infrastructure assistance data signals, generates corresponding control signals, and outputs them in line with the concept described here.

FIG. 5 shows a machine-readable storage medium 501 on which a computer program 503 is stored.

The computer program 503 comprises commands that, when the computer program 503 is executed by a computer, cause the computer to carry out a method in accordance with the first aspect and/or in accordance with the second aspect.

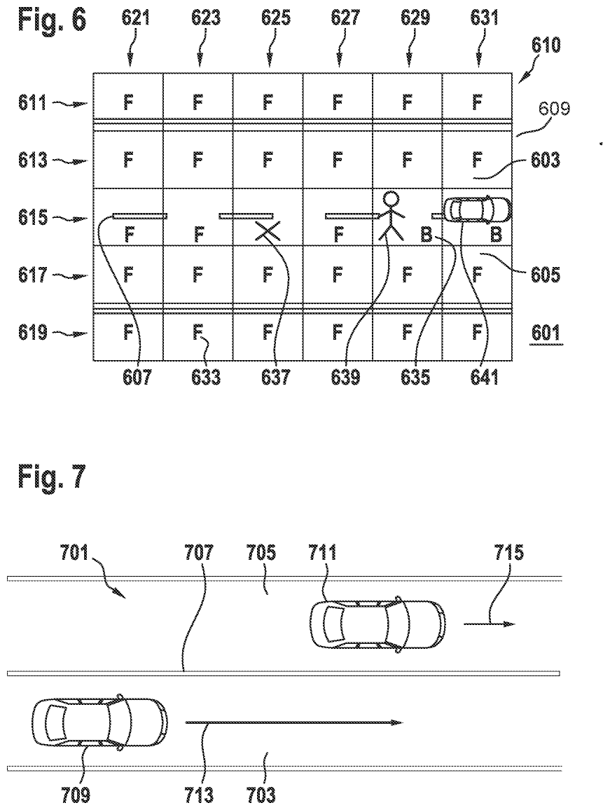

FIG. 6 shows in schematic form an analysis result of an environment of a motor vehicle, the vehicle not being shown for clarity.

The environment comprises a road 601 on which the motor vehicle is currently traveling. The road 601 comprises a first lane 603 and a second lane 605 that are separated from one another by a broken line 607.

The environment is subdivided into a plurality of cells 609 according to the analysis result. The plurality of cells 609 are arranged in the form of a table 610.

The table 610 comprises a first row 611, a second row 613, a third row 615, a fourth row 617, and a fifth row 619.

The table 610 comprises a first column 621, a second column 623, a third column 625, a fourth column 627, a fifth column 629, and a sixth column 631.

The analyzing of the environment, in line with the concept described here, comprises in one specific embodiment a free space recognition and an object recognition.

For cells 609 for which it has been recognized that they are free, in FIG. 6 the letter F for “free”, labeled with the reference numeral 633, is marked in. For cells 609 that are occupied, the letter B, labeled with the reference numeral 635, for “belegt” (in German), i.e., “occupied”, has been marked in. For a cell 609 for which it has not been possible to recognize whether it is occupied or free, an X, labeled with the reference numeral 637, has been marked in.

According to the free space recognition, all the cells 609 of the table 610 are free except for the cells 609 according to the third row 615, fifth column 629 and sixth column 631, that have been recognized as occupied, and for the cell 609 according to the third row 615 and according to the third column 625, for which no occupancy has been able to be recognized, so a corresponding occupancy status is unknown.

According to the object recognition, two objects were recognized: a pedestrian 639 and a further motor vehicle 641. According to the object recognition, the pedestrian 639 is located in the cell 609 according to the third row 615 and according to the fifth column 629. According to the object recognition, the further motor vehicle 641 is located in the cell 609 according to the third row 615 and according to the sixth column 631.

Thus, the results of the object recognition correspond to the results of the free space recognition.

The cells 609 are areas in the context of the description.

For example, this analysis result is communicated as a whole to the motor vehicle. For example, this analysis result is communicated to the motor vehicle only in parts. “In parts” may for example mean that information is communicated to the motor vehicle only for cells 609 for which an “occupied” has been recognized or an object has been detected. For example, only changes in relation to a prior analysis result are transmitted to the motor vehicle.

Although it has not been shown here, a detected object may also be distributed over a plurality of cells 609, i.e., occupy a plurality of cells 609.

FIG. 7 shows a road 701 comprising a first lane 703 and a second lane 705 that are separated from each other by a continuous line bearing the reference numeral 707.

A first motor vehicle 709 is traveling in the first lane 703. A second motor vehicle 711 is traveling in the second lane 705.

The first motor vehicle 709 is intended for example to continue traveling further along a determined trajectory, namely further in the first lane 703. This trajectory is symbolized by an arrow bearing the reference numeral 713.

A direction of travel of the second motor vehicle 711 is symbolized by an arrow bearing the reference numeral 715.

In line with the concept described here, the infrastructure ascertains whether it is safe or not safe for the first motor vehicle 709 to continue traveling along the trajectory 713. For this, an environment of the first motor vehicle 709 is acquired by infrastructure environment sensors, with the environment of the first motor vehicle 709 being analyzed based on this acquisition, this analyzing comprising an object recognition and/or a free space recognition. According to a corresponding analysis result, merely the second motor vehicle 711 is detected in the environment of the motor vehicle 709, and/or a cell of a table, not shown, analogous to FIG. 6 is recognized as being occupied, with the remaining cells of the table having been recognized as being free. Thus, in the current traffic situation, the first motor vehicle 709 continuing to travel along the determined trajectory 713 does not lead to a collision with the second motor vehicle 711, so it can be signaled to the first motor vehicle 709 that it is OK to continue traveling accordingly. Thus, the first motor vehicle 709 knows that it can continue to travel in safety.

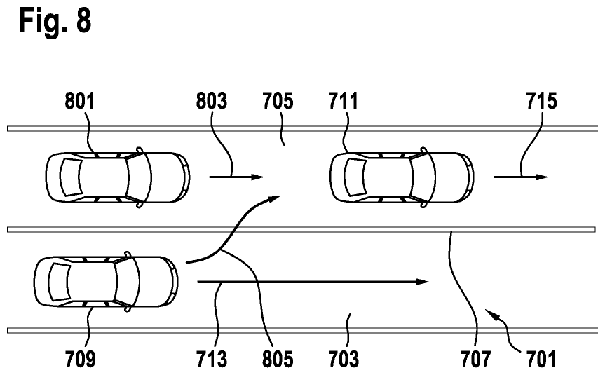

FIG. 8 shows the situation according to FIG. 7, wherein additionally a third motor vehicle 803 is traveling in the second lane 705 in the direction of travel, marked by an arrow bearing the reference numeral 803. The third motor vehicle 801 is traveling behind the second motor vehicle 711.

The infrastructure predicts a behavior of the first motor vehicle 709 based on the environment signals. For example, alternatively or additionally, the first motor vehicle 709 may communicate an intended driving behavior to the infrastructure. This driving behavior, according to the exemplary embodiment shown in FIG. 8, comprises the first motor vehicle 709 wanting to change lane and wishing to pull in between the two motor vehicles 801, 711, which is symbolized by a further trajectory 805. This driving maneuver may for example also be recognized based on a prediction of the behavior of the first motor vehicle 709.

However, such a driving maneuver leads to a critical situation if for example corresponding distances between the motor vehicles are too short to still be able to react, for example brake, in a timely manner in the event of unexpected maneuvers of the individual motor vehicles.

For example, the third motor vehicle 801 signals to the infrastructure that it wants to accelerate shortly. The infrastructure therefore knows that a distance between the third motor vehicle 801 and the second motor vehicle 711 will reduce still further, so a corresponding gap for the first motor vehicle 709 to pull in becomes too small.

In this respect, the infrastructure ascertains that it is unsafe for the first motor vehicle 709 to travel along the further trajectory 805. This is signaled to the first motor vehicle 709 by the infrastructure, so that the first motor vehicle 709 can for example break off its planned driving maneuver.

In summary, the concept described here is based in particular on the infrastructure, on the basis of its own environment sensors and environment analysis methods (object detection and/or free space recognition), transmitting for example object data and/or free/occupied area data to the motor vehicle.

Preferably, information is also transmitted to the motor vehicle about areas on which possibly no information exists and/or has been able to be ascertained, the occupancy status of which is therefore unknown. This is, for example, because of environment sensor/analysis problems and/or obscuring (e.g., if motor vehicles are between the environment sensors and an area/region).

For results such as for example detected objects and/or recognized occupancy status of areas, preferably the respective descriptive static and dynamic data are transmitted, e.g.: position, dimension, color, speed, acceleration, etc.

For example, owing to the dynamic situation analysis results are transmitted regularly/continuously/periodically to the motor vehicle.

In one specific embodiment, all the analysis results are transmitted repeatedly.

In one specific embodiment, only updates/changes to the previous version of the analysis results are transmitted.

In one specific embodiment, only analysis results relating to one or more regions that lie ahead of the motor vehicle are transmitted to the motor vehicle.

Due to the regular transmission of the analysis results to the motor vehicle, the analysis results are current (changes in the scene are contained) and failure of the transmission can automatically be regarded as a fault in the communication.

In a further specific embodiment, the infrastructure continuously/periodically/regularly transmits an “all okay” signal.

That is to say, the infrastructure analyzes the traffic scene of all the environment data or at least of those that are necessary/essential for the determined motor vehicle.

That is to say, the route is safe for the vehicle. The analysis in this case is ascertained for example based on data analyzed and predicted in the infrastructure itself and/or routes/trajectories transmitted by the motor vehicle. Preferably in one specific embodiment from normal travel aspects and/or comfort travel aspects and/or from emergency reaction travel aspects.

In one specific embodiment, the infrastructure transmits an “emergency signal” analogously to the case for “all okay”, but here not continuously/periodically/regularly, but situationally in the event of problems, preferably with data on what the problem is.

In one specific embodiment, the infrastructure ascertains and transmits action signals and/or action proposals, e.g., emergency stop and trajectories. The trajectories may be the normal travel trajectories and/or emergency reaction trajectories (emergency trajectories).

The trajectories in one specific embodiment may again, as with the object data, be transmitted “entirely or partially” and also periodically/regularly/continuously.

In one specific embodiment, the infrastructure includes a “measure of accuracy” in the transmission, i.e., how accurate and reliable the data are.

“Data” here are the infrastructure assistance data that the motor vehicle receives.

In addition to the data, the “can I trust data contents” is important.

To this end, the data are checked for example by the motor vehicle,

In one specific embodiment on the basis of the data from the vehicle.

In one specific embodiment on the basis of reference data (e.g., from a map).

In one specific embodiment, this is analyzed “from time to time”.

In one specific embodiment, this is analyzed continuously, including analyzing whether the data fit with the previous analysis and/or analyses (no “jump” in the analyses).

In addition to the data, the timed transmission of the infrastructure assistance data signals may for example be important.

If the regular/continuous/periodic data transmission fails to materialize (with the exception of the emergency reaction signal), then for example it can be assumed that the communication and/or the infrastructure has/have a fault.

The consequence may include, for example, that the motor vehicle has to continue traveling using its own, i.e., motor vehicle, data.

That is to say, that travel is continued in an at least partially automated manner no longer, as previously, based (partly or exclusively) on infrastructure assistance data but on motor vehicle data.

Preferably the motor vehicle, in parallel (prior to the failure having been detected), has already planned at least partially automated travel based on motor vehicle data and/or on infrastructure assistance data in the event of a fault.

For example, it may activate a fallback level, i.e., change into a fallback level state, a fallback level of this kind as a rule being implemented in every motor vehicle, these fallback levels possibly being dependent on the level of automation, i.e., possibly being different. For example, the fallback levels for the automation levels 3 and 4 differ.

For example, the motor vehicle may travel along the transmitted emergency reaction trajectories, described above, of the infrastructure in an at least partially automated manner.

1-25. (canceled)

26. A method for the infrastructure-supported assistance of a motor vehicle in an at least partially automated driving task, comprising the following steps:
receiving environment signals that represent an environment of the motor vehicle;
analyzing the environment to ascertain an analysis result, wherein the analyzing includes: (i) an object recognition to detect an object in the environment of the motor vehicle, and/or (ii) a free space recognition to recognize an occupancy of an area in the environment of the motor vehicle to ascertain an occupancy status that indicates whether the area is free or occupied, wherein the analysis result indicates: (i) whether an object has been detected in the environment of the motor vehicle, and/or (ii) the ascertained occupancy status of the area in the environment of the motor vehicle;
generating infrastructure assistance data signals that represent infrastructure assistance data for the infrastructure-supported assistance of the motor vehicle in an at least partially automated driving task, based on the analysis result; and
outputting the infrastructure assistance data signals.

27. The method as recited in claim 26, wherein the infrastructure assistance data signals are generated based on the analysis result in such a way that the infrastructure assistance data include the analysis result.

28. The method as recited in claim 26, wherein the analysis result is compared with a prior analysis result to ascertain one or more changes in relation to the prior analysis result, wherein the infrastructure assistance data signals are generated based on the one or more ascertained changes.

29. The method as recited in claim 28, wherein the infrastructure assistance data signals are generated based on the one or more ascertained changes in such a way that the infrastructure assistance data include the one or more ascertained changes and are free from the analysis result.

30. The method as recited in claim 26, wherein, when no occupancy of the area was able to be recognized using the free space recognition, the occupancy status indicates that the occupancy of the area is unknown.

31. The method as recited in claim 26, wherein, when using the free space recognition, and additionally using the object recognition, no clear result was able to be ascertained, the occupancy status indicates that the occupancy of the area is unknown.

32. The method as recited in claim 26, wherein when, using the free space recognition, and additionally using the object recognition, it is ascertained that the area cannot be examined, the occupancy status indicates that the occupancy of the area is unknown.

33. The method as recited in claim 26, wherein, based on the analysis result, a traffic scene in the environment of the motor vehicle is analyzed to see whether or not it is safe for the motor vehicle to travel along a determined trajectory, wherein the infrastructure assistance data signals are generated based on the analysis of the traffic scene, so that the infrastructure assistance data include the information of whether or not it is safe for the motor vehicle to travel along the determined trajectory.

34. The method as recited in claim 33, wherein a behavior of the motor vehicle is predicted, and wherein the determined trajectory is ascertained based on the predicted behavior.

35. The method as recited in claim 33, wherein trajectory signals that represent a trajectory planned using the motor vehicle along which the motor vehicle is intended to be guided in an at least partially automated manner are received, the determined trajectory being ascertained based on the planned trajectory.

36. The method as recited in claim 33, wherein the traffic scene is analyzed from comfort travel aspects and/or from emergency reaction travel aspects to ascertain whether or not it is safe for the motor vehicle to travel along the determined trajectory based on the comfort travel aspects and/or the emergency reaction trave aspects, so that the infrastructure assistance data include the information of whether or not it is safe for the motor vehicle to travel along the determined trajectory from the comfort travel aspects and/or the emergency reaction trave aspects.

37. The method as recited in claim 33, wherein in the case of unsafe travel along the predetermined trajectory, emergency signals that indicate that if the motor vehicle travels along the determined trajectory an emergency may occur for the motor vehicle are generated and output.

38. The method as recited in claim 37, wherein the emergency signals are generated in such a way that the emergency signals describe the emergency.

39. The method as recited in claim 26, wherein action recommendation signals that represent one or more action recommendations for the motor vehicle are generated and output based on the analysis result.

40. The method as recited in claim 26, wherein a respective measure of confidence, indicating how accurate and/or reliable information represented by the output signals is, is ascertained for the output signals.

41. The method as recited in claim 26, wherein: (i) the object recognition includes one or more object properties of a recognized object, so that a result of the object recognition indicates the one or more ascertained object properties, and/or (ii) the free space recognition includes ascertaining one or more area properties of the area, so that a result of the free space recognition indicates the one or more ascertained area properties.

42. The method as recited in claim 41, wherein each of the one or more object properties is an element selected from the following group of object properties: position, dimension, color, speed, acceleration, nature.

43. The method as recited in claim 41, wherein each of the one or more ascertained area properties is selected from the following group of area properties: position, dimension, color, nature.

44. A method for the at least partially automated guidance of a motor vehicle, comprising the following steps:
receiving infrastructure assistance data signals that represent infrastructure assistance data for the infrastructure-supported assistance of the motor vehicle in an at least partially automated driving task, wherein the infrastructure assistance data include: (i) an analysis result that indicates: (a) whether an object has been detected in the environment of the motor vehicle, and/or (b) an occupancy status of an area in the environment of the motor vehicle, and/or (ii) one or more changes in relation to a prior analysis result that indicated: (a) whether an object had been detected in the environment of the motor vehicle, and/or (b) an occupancy status of an area in the environment of the motor vehicle;
generating control signals for the at least partially automated control of a lateral and/or longitudinal guidance of the motor vehicle based on the infrastructure assistance data signals; and
outputting the generated control signals.

45. The method as recited in claim 44, wherein the received infrastructure assistance data signals are checked for how accurate and/or reliable information that the received infrastructure assistance data signals represent is, the control signals being generated based on a result of the check.

46. The method as recited in claim 45, wherein the received signals are checked based on onboard data of the motor vehicle as a reference relative to the information that the corresponding received infrastructure assistance data signals represent.

47. The method as recited in claim 44, wherein it is established that the received signals, except for emergency signals that indicate that in the event of the motor vehicle traveling along a determined trajectory an emergency may occur for the motor vehicle, are heartbeat signals, so that received signals, except for emergency signals, are checked to see whether they have been received in accordance with the heartbeat that is to be expected.

48. A device configured for the infrastructure-supported assistance of a motor vehicle in an at least partially automated driving task, the device configured to:
receive environment signals that represent an environment of the motor vehicle;
analyze the environment to ascertain an analysis result, wherein the analyzing includes: (i) an object recognition to detect an object in the environment of the motor vehicle, and/or (ii) a free space recognition to recognize an occupancy of an area in the environment of the motor vehicle to ascertain an occupancy status that indicates whether the area is free or occupied, wherein the analysis result indicates: (i) whether an object has been detected in the environment of the motor vehicle, and/or (ii) the ascertained occupancy status of the area in the environment of the motor vehicle;
generate infrastructure assistance data signals that represent infrastructure assistance data for the infrastructure-supported assistance of the motor vehicle in an at least partially automated driving task, based on the analysis result; and
output the infrastructure assistance data signals.

49. A non-transitory machine-readable storage medium on which is stored a computer program for the infrastructure-supported assistance of a motor vehicle in an at least partially automated driving task, the computer program, when executed by a computer, causing the computer to perform the following steps:
receiving environment signals that represent an environment of the motor vehicle;
analyzing the environment to ascertain an analysis result, wherein the analyzing includes: (i) an object recognition to detect an object in the environment of the motor vehicle, and/or (ii) a free space recognition to recognize an occupancy of an area in the environment of the motor vehicle to ascertain an occupancy status that indicates whether the area is free or occupied, wherein the analysis result indicates: (i) whether an object has been detected in the environment of the motor vehicle, and/or (ii) the ascertained occupancy status of the area in the environment of the motor vehicle;
generating infrastructure assistance data signals that represent infrastructure assistance data for the infrastructure-supported assistance of the motor vehicle in an at least partially automated driving task, based on the analysis result; and
outputting the infrastructure assistance data signals.
